(19) United States
(12) Patent Application Publication
(10) Pub. No.: US 2025/0104219 A1
(43) Pub. Date: Mar. 27, 2025

(54) ENHANCED QUALITY CONTROL USING MACHINE LEARNING

(71) Applicant: ELECTRICAL COMPONENTS INTERNATIONAL, INC., St. Louis, MO (US)

(72) Inventors: Jarred Knecht, Westmount (CA); Kyryll Zaytsev, Saint-Laurent (CA)

(21) Appl. No.: 18/893,230

(22) Filed: Sep. 23, 2024

Related U.S. Application Data
(60) Provisional application No. 63/540,777, filed on Sep. 27, 2023.

(51) Int. Cl. G06T 7/00; G06V 10/764; G06V 10/774

(52) U.S. Cl. CPC G06T 7/001; G06V 10/764; G06V 10/774; G06T 2207/20081; G06T 2207/30164

(57) ABSTRACT

A method of employing quality control on a product includes receiving a unique identifier of a previously finished product having a finished product dataset that had been evaluated against an original dataset. The finished product dataset has a finished product feature class. The finished product dataset is compared to a new dataset, and a revised feature class is discovered relative to the finished product feature class based upon the new dataset. The new dataset is modified with the revised feature class to provide a revised dataset. An unfinished product is evaluated with the revised dataset.

### CROSS-REFERENCE TO RELATED APPLICATION

This application claims priority to U.S. Provisional Application No. 63/540,777 filed Sep. 27, 2023.

### TECHNICAL FIELD

The present invention relates generally to methods and systems for improving quality control inspection using a previously finished product (e.g., a wire harness) using a machine learning (ML) model to modify the standards for acceptable and unacceptable product features.

### BACKGROUND

Wire harnesses (also known as cable harnesses, cable assemblies, wiring assemblies, or wiring looms) are assemblies of electrical cables or wires that transmit signal and/or electrical power. Wire harnesses are commonly used in, for example, a vehicle, such as, an automobile, a heavy duty transportation vehicle, such as a semi-truck, a train, a trolley or a cable car, a construction machine, a watercraft, such as a cargo vessel, an inter-island boat or a jet ski, and a spacecraft. Wire harnesses are primarily manufactured by hand. Wire harnesses are inspected during one or more stages of their manufacture to ensure quality and/or functionality. Inspection by human inspectors is time consuming, especially where inspection is required at multiple stages of manufacture.

Automated optical inspection (AOI) systems are used for automated visual inspection of products such as printed circuit boards (PCBs). However, AOI systems require extensive programming of what acceptable and unacceptable product features are including specific dimensional tolerances, which must be developed and loaded manually by the operator. Moreover, conventionally programmed AOI systems are not adaptable or flexible, and instead require re-programming if the environment (e.g., lighting) changes or if there are small variations in the product features. That is, conventionally programmed AOI systems require static dimensional tolerances, and, if part-to-part variation is allowed, the static dimensional tolerances are wider than necessary.

AOI systems have been proposed for use in the production of wiring harnesses. While these systems represent a significant advancement in the quality of the finished wiring harness product, further improvement is desired.

### SUMMARY

A method of employing quality control on a product includes receiving a unique identifier of a previously finished product having a finished product dataset that had been evaluated against an original dataset. The finished product dataset has a finished product feature class. The finished product dataset is compared to a new dataset, and a revised feature class is discovered relative to the finished product feature class based upon the new dataset. The new dataset is modified with the revised feature class to provide a revised dataset. An unfinished product is evaluated with the revised dataset.

These and other features of the present invention can be best understood from the following specification and drawings, the following of which is a brief description.

### BRIEF DESCRIPTION OF THE DRAWINGS

The disclosure can be further understood by reference to the following detailed description when considered in connection with the accompanying drawings wherein:

FIG. 1 is a block diagram of an inspection system according to some aspects of the disclosure.

FIG. 2 is a block diagram of an inspection station of an inspection system according to some aspects of the disclosure.

FIG. 3 is a block diagram of a training station of an inspection system according to some aspects of the disclosure.

FIG. 4 is a flowchart illustrating a training process according to some aspects of the disclosure.

FIG. 5 is a flowchart depicting the disclosed method of quality control.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

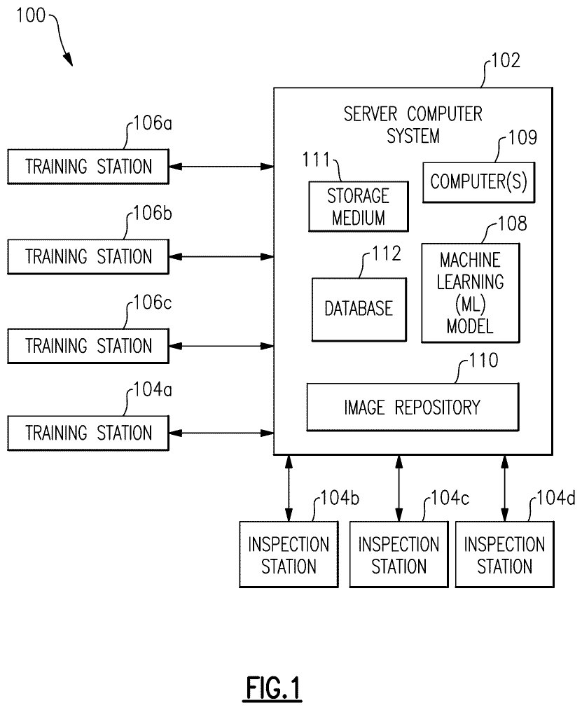

An example inspection system 100 is shown in FIG. 1. Details of this inspection system 100 are described in U.S. patent application Ser. No. 17/853,188 entitled “NEXT GENERATION QUALITY INSPECTION”, filed on Jun. 29, 2022, which is incorporated herein by reference in its entirety.

In the example, the inspection system 100 includes a computer system 102 and one or more inspection stations 104 (e.g., 104a-104d) wherein unfinished products are inspected at one or more times throughout the product assembly operation. If desired, the inspection station 100 may include one or more training stations 106 (e.g., 106a-106c) where, through machine learning, the inspection system 100 learns how to evaluate the quality of the unfinished product throughout the product assembly process.

With continuing reference to FIG. 1, the computer system 102 includes a machine learning (ML) model 108, one or more computers 109, an image repository 110, a storage medium 111, and/or a database 112 that are in communication one another, as desired, to provide the disclosed quality control. The ML model 108 is configured to perform object detection for various features during the assembly process. In the example of a wiring harness, the features may include the quality and or placement of one or more of a crimp connector (e.g., Rosenberger (RSBRG) connector, lug connector, and/or Amphenol connector), an endcap, a tie wrap, a sleeve, a crimp, a jacket, a lug, a heated heat shrink, welding, and/or a shield braid. The ML model 108 can determine whether one or more of these features are acceptable or unacceptable.

The one or more computers 109 may be configured to communicate with and/or control the ML model 108, the image repository 110, the storage medium 111, and/or the database 112. The computer system 102 may store the captured product image in the image repository 110. The storage medium 111 may store the image repository 110 and/or the database 112, which includes one or more datasets relating to previously finished products each having a unique identifier and that have already received a final verdict as to whether the previously finished product as received an approval or a disapproval. Each dataset may also include information relating each feature and whether it has been judged acceptable or unacceptable (i.e., its feature class).

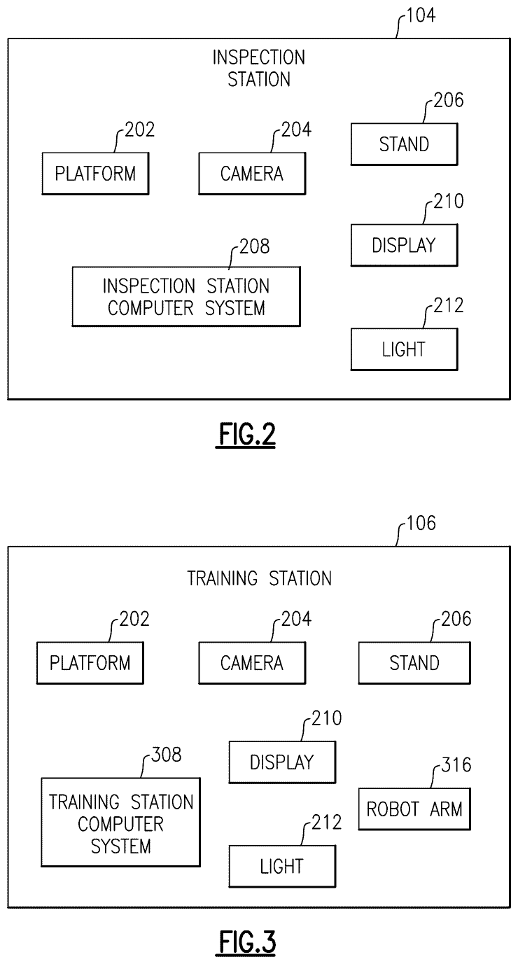

Referring to FIG. 2, the datasets are accumulated at the inspection station 104. One example dataset includes a unique identifier, a product feature class, a captured product image, a final verdict and/or an inspection log. A camera 204 supported by a stand 206 is arranged above a platform 202. The stand 206 may also include a light 212 configured to shine on the platform 202. A product in various stages of completion during the assembly process is arranged on the platform 202 beneath the camera 204 and light 212. The camera 204 obtains captured product images of the product, which may be processed and/or stored by an inspection station computer system 208. Those captured product images may be reproduced on a display 210 at the inspection station 104. The feature class (i.e., acceptable or unacceptable) may be shown on the display 210 in real-time along with the captured product image(s) for the feature or features being inspected.

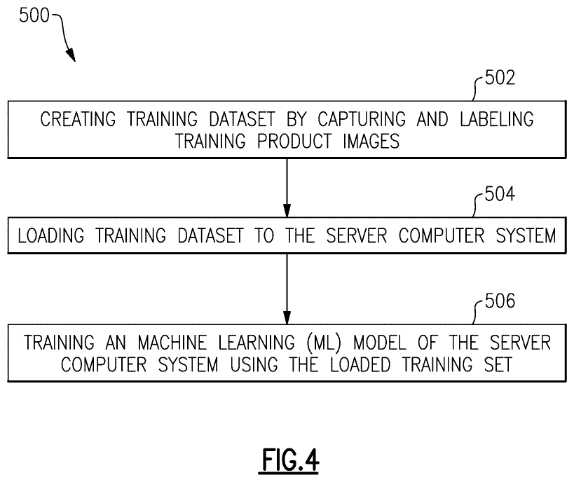

The training station 106, shown in FIG. 3, may be similar to the inspection station 104 but may additionally include a robot arm 316 for providing repeatable presentation of the feature on the product to the camera 204 and which is processed and/or stored by a training station computer system 308.

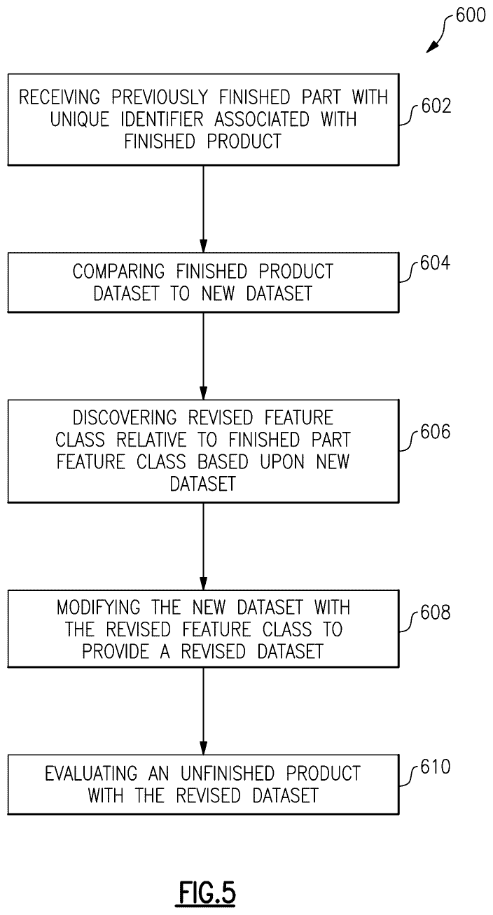

An example training process 500 using the training station 106 is shown in FIG. 4. The training process 500 trains the ML model 108 to detect objects of a set of classes (i.e., acceptable or unacceptable) in images of the product, including one or more product features to be inspected during assembly of the product. The training process 500 includes a step 502 of creating a training dataset using a sufficient number of training products.

The training process 500 also includes a step 504 of loading the training dataset to the computer system 102. In some aspects, the training station 106 (e.g., the training station computer system 308 of the training station 106) may load the training dataset to the computer system 102 (e.g., to a shared drive of the storage medium 111 of the server computer system 102). The training process 500 further includes a step 506 of training the ML model 108 using the loaded training dataset. In some aspects, the step 506 may include the computer system 102 moving the training dataset from the shared drive of the storage medium 111 to a training area (e.g., a training area of the storage medium 111 or of the ML model 108). In some aspects, the step 506 may include the server computer system 102 (e.g., the one or more computers 109 and/or the ML model 108) performing a data preprocessing step to ensure that the training dataset (e.g., the label text files of the training dataset) includes proper class indexes. For example, in some aspects, the data preprocessing step may check that identifications of the classes of the objects in the training product images all fall within a range of possible class identifications. The step 506 may include the computer system 102 (e.g., the one or more computers 109 and/or the ML model 108) splitting the training dataset into a training set and a testing set (e.g., 85% and 15%, respectively).

The end result of finish products (e.g., wiring harnesses) produced using the disclosed inspection system 100 are reliable, high quality products that can be confidently sent to an end user (e.g., customer) for installation and use. Rarely the end user may have an inquiry related to the final verdict of the previously finished product (e.g., question whether the finished product was properly approved), which may be due to a failure during assembly or in the field. The disclosed inspection system 100 leverages this interaction with the end user to further improve quality control of subsequently produced finished products as well as satisfactorily resolve the inquiry from the end user.

In the example method 600 shown in FIG. 5, the method 600 of employing enhanced quality control on a product includes receiving a unique identifier (e.g., tag with bar or QR code) of a previously finished product (block 602) that has been to the end user, for example. At least initially, the unique identifier may be provided by the end user by simply communicating an alphanumeric portion of the label or an image of the unique identifier to a contact at the manufacturing facility of the finished product, for example. With this information, the finished product dataset for the previously finished product can be accessed. Once accessed, one can revisit the finished product features classes (i.e., acceptable or unacceptable for each feature) and the final verdict (approved or disapproved) for the previously finished product. Since the previously finished product was released to the end user for installation and use, all feature classes should be “acceptable” and the final verdict should be “approved.” Corroboration of all features being acceptable can be corroborated by accessing a photo (captured product images) image repository 110, and then providing captured product images to the end user for proof, if desired.

This approach may be sufficient to settle the quality of the previously finished product and confirm that there was no defect in the product that led to the inquiry. Otherwise it may be desirable to re-inspect the previously finished product in which case the actual previously finished product must be obtained for use by the inspection system 100. The previously finished product may be scanned by the camera 204 at the inspection station 104, which accesses the finished product dataset associated with the scanned unique identifier. The finished product dataset in the image repository 110. The image repository 110 stores the conveyed captured product image and, for each detected object the identification of the class of the detected object and the identification of the region of the detected object in the captured product image.

Since it is likely the original product data set by which the finished product dataset has grown, the finished product dataset can be compared to (i.e., re-run against) a new dataset (block 606) that is presumably larger and more accurate than the original dataset. For example, the probabilities for determining the product feature classes may be more accurate and/or the probability thresholds may have changed since the previous finished product was produced. As a result, a potentially different, revised feature class may be discovered relative to the finished product feature class (now unacceptable, although it was previously acceptable using the original data set) based upon the new dataset (block 606). This process includes positioning a portion of the previously finished product under the camera 204 to obtain a captured product image. In one example, the previously finished product is unmodified during the positioning step (i.e., non-destructive testing), and in another example, a portion of the previously finished product is removed (i.e., destructive testing) prior to performing the positioning step.

If the previously finished product is again determined to be approved (all feature classes remain acceptable even against the new dataset), verification is provided to the customer regarding the final verdict. As part of the verification to the customer, a captured product image of the previously finished product from the image repository can be provided.

Assuming new information is gleaned from re-inspection of the previously finished product, the new dataset (i.e., current dataset use to inspect products during assembly) is modified or updated with the revised feature class to provide a revised dataset (block 608). The inspector log of the previously finished product can be updated to reflect any revised feature classes that have been discovered. Going forward, unfinished products can be evaluated with the revised dataset (block 610) to provide an even more accurate, robust inspection system 100.

The discovering step of block 606 may include detecting with the machine learning (ML) model 108 at least one object in the captured product image and providing for each detected object an identification of a class of the detected object and an identification of a region of the detected object in the captured product image. The class of the detected object is either an acceptable product feature class or an unacceptable product feature class. For each detected object, the identification of the class of the detected object and the identification of the region of the detected object in the captured product image are received. It may be desirable to display to the operator at an inspection station an enhanced product image that includes the conveyed captured product image to which the identification of the class of the detected object and the identification of the region of the detected object in the captured product image for each detected object added.

As part of detecting the objects in the captured product image, it may be desirable for each class of a set of classes using the ML model to determine a probability that the captured product image includes an object of the class in a region of the captured product image. For each determined probability that exceeds a probability threshold, it can be determining that the region of the captured product image includes the object of the class.

The modifying step of block 608 may include training the machine learning (ML) model 108 with the finished product dataset, as described relative to FIG. 4. This may be particularly useful in cases where the original final verdict of the previously finished product was acceptable, but has been determined to be unacceptable in view of the new dataset. The training includes loading a training dataset (block 504) including the finished product dataset into the computer system 102. The training dataset comprises training product images and, for each training product image of the training product images, an identification of a class of an object in the training product image and an identification of a region of the object in the training product image. The class of the object is either an acceptable product feature class or an unacceptable product feature class. The ML model 108 is trained using the loaded training dataset (block 506).

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A method of employing quality control on a product, comprising:
receiving a unique identifier of a previously finished product having a finished product dataset that had been evaluated against an original dataset, the finished product dataset has a finished product feature class;
comparing the finished product dataset to a new dataset;
discovering a revised feature class relative to the finished product feature class based upon the new dataset;
modifying the new dataset with the revised feature class to provide a revised dataset; and
evaluating an unfinished product with the revised dataset.

2. The method of claim 1, wherein the receiving step includes receiving an inquiry from a customer regarding a final verdict of the previously finished product associated with the unique identifier, and comprising a step of providing a verification to the customer regarding the final verdict.

3. The method of claim 2, wherein the final verdict includes an approval or a disapproval of the previously finished product.

4. The method of claim 2, wherein the finished product dataset includes an image repository, and comprising a step of accessing the image repository, and the verification includes providing a captured product image from the image repository to the customer.

5. The method of claim 4, comprising using the image repository to store a conveyed captured product image and, for each detected object, an identification of the class of the detected object and an identification of a region of the detected object in the captured product image.

6. The method of claim 1, wherein the receiving step includes scanning the unique identifier located on the previously finished product.

7. The method of claim 6, wherein the discovering step includes positioning a portion of the previously finished product under a camera to obtain a captured product image.

8. The method of claim 7, wherein the previously finished product is unmodified during the positioning step.

9. The method of claim 7, wherein a portion of the previously finished product is removed prior to performing the positioning step.

10. The method of claim 7, wherein the comparing step includes:
detecting with a machine learning (ML) model at least one object in the captured product image and providing for each detected object an identification of a class of the detected object and an identification of a region of the detected object in the captured product image, wherein the class of the detected object is either an acceptable product feature class or an unacceptable product feature class;
receiving for each detected object, the identification of the class of the detected object and the identification of the region of the detected object in the captured product image; and
displaying at an inspection station an enhanced product image that includes a conveyed captured product image to which the identification of the class of the detected object and the identification of the region of the detected object in the captured product image for each detected object added.

11. The method of claim 10, wherein the step of detecting the objects in the captured product image comprises:
for each class of a set of classes using the ML model to determine a probability that the captured product image includes an object of the class in a region of the captured product image; and
for each determined probability that exceeds a probability threshold, determining that the region of the captured product image includes the object of the class.

12. The method of claim 11, wherein the finished product is a wire harness, and the feature classes are wire harness features.

13. The method of claim 12, wherein the set of classes includes two or more of the following classes: an acceptable endcap placement class, an unacceptable endcap placement class, an acceptable tie wrap class, an unacceptable tie wrap class, an acceptable sleeve placement class, an unacceptable sleeve placement class, an acceptable crimp class, an unacceptable crimp class, an acceptable jacket placement class, an unacceptable jacket placement class, an acceptable placed lugs class, an unacceptable placed lugs class, an acceptable heated heat shrink class, an unacceptable heated heat shrink class, an acceptable weld class, an unacceptable weld class, an acceptable shield braid class, and an unacceptable shield braid class.

14. The method of claim 1, wherein the modifying step includes training a machine learning (ML) model with the finished product dataset.

15. The method of claim 14, wherein the training step comprises:
loading a training dataset including the finished product dataset into a server computer system, wherein the training dataset comprises training product images and, for each training product image of the training product images, an identification of a class of an object in the training product images and an identification of a region of the object in the training product images, wherein the class of the object is either an acceptable product feature class or an unacceptable product feature class; and
training the ML model using the loaded training dataset.

16. The method of claim 1, wherein the modifying step includes updating an inspector log of the previously finished product to reflect the revised feature class.
